(19) United States
(12) Patent Application Publication
(10) Pub. No.: US 2024/0020537 A1
(43) Pub. Date: Jan. 18, 2024

(54) METHODOLOGY TO GENERATE EFFICIENT MODELS AND ARCHITECTURES FOR DEEP LEARNING

(71) Applicant: Groq, Inc., Mountain View, CA (US)

(72) Inventors: Andrew Chaang Ling, Toronto (CA); Aidan Robert Byron Wood, Toronto (CA); Baorui Zhou, Toronto (CA); Andrew Esper Bitar, Toronto (CA); Jonathan Alexander Ross, Palo Alto, CA (US)

(21) Appl. No.: 18/352,784

(22) Filed: Jul. 14, 2023

Related U.S. Application Data
(60) Provisional application No. 63/389,673, filed on Jul. 15, 2022.

(51) Int. Cl. G06N 3/08; G06N 3/04

(52) U.S. Cl. CPC G06N 3/08; G06N 3/04

(57) ABSTRACT

A system and method of generating an efficient neural network model architecture and an efficient processor for deep learning in an artificial intelligence (AI) processor are provided. The system and method to create the processor architecture as a companion to the neural network model by composing a plurality of processor architectures to enable architectural exploration. The compilation can be implemented for any arbitrary spatial processor architecture using either ASIC or FPGA devices. The processor architecture can be uniquely defined for a selected ML or AI model without having to update the software compiler.

### CROSS-REFERENCE TO RELATED APPLICATIONS

This application claims a benefit, and priority, under 35 U.S.C. § 119(e) to U.S. Provisional Patent Application Ser. No. 63/389,673, titled “Processor Architecture Modeling for Deep Learning,” filed on Jul. 15, 2022, which is hereby incorporated by reference in its entirety. This application is related to a commonly assigned application entitled PROCESSOR ARCHITECTURE MODELING FOR DEEP LEARNING filed on Jul. 14, 2023, U.S. patent application Ser. No. 18/352,602, which also claims priority to U.S. Ser. No. 63/389,673 filed Jul. 15, 2022, which are hereby incorporated by reference in their entireties.

### SPECIFICATION—DISCLAIMERS

In the following Background, Summary, and Detailed Description, paragraph headings are signifiers that do not limit the scope of an Embodiment of a Claimed Invention (ECIN). The citation or identification of any publication signifies neither relevance nor use as prior art. A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### TECHNICAL FIELD

The present disclosure relates to a tensor streaming processor architecture.

### BACKGROUND

Machine learning model applications are being used in a large number of applications that require fast, e.g., real time, processing time for the output of the machine learning model. However, current means of implementing machine learning models cannot guarantee that execution can meet both time and power constraints. For example, graphics processing units (GPUs) are commonly used to execute machine learning models. However, a GPU may not necessarily consistently return results within the specified time constraints needed for the real-time operation of the system, and may often unexpectedly generate peak power draws that exceed the platform capabilities of the vehicle. For this reason, many new chip architectures have recently been proposed that are based on a sea of CPU cores or custom accelerator chips such as the TPU or the TSP.

Modeling performance of new chip architectures has been typically done post-tape out or after first silicon of the chip is returned from manufacturing since the overall performance and behavior of the chip is unknowable due to reactive components that comprise many such architectures.

### SUMMARY

This Summary, together with any Claims, is a brief set of signifiers for at least one ECIN (which can be a discovery, see 35 USC 100(a); and see 35 USC 100(j)), for use in commerce for which the Specification and Drawings satisfy 35 USC 112.

Due to the deterministic nature of a Tensor Streaming Processor (TSP) based on the Groq, Inc. deterministic architecture, performance optimization and development in the compiler can occur well before the chip is available. Advantageously, no simulator is required to achieve the optimizations or to finalize development. Secondly, because the Groq TSP has no reactive components, and all functional units are fixed in terms of latency and size, a composer can model performance with 100% accuracy within the compiler and hence performance characterize the chip long before tapeout or manufacturing.

In one ECIN, a processor architecture composer passes a processor model to a compiler to determine whether a machine learning model will meet selected performance constraints prior to having silicon available to exercise. This is possible due to the deterministic nature of all functional units and fixed latency between processors such that exact performance results can be estimated after compiling to a virtual device. Contrast this capability with the prior art technology where a user has a static processor architecture that is a best initial fit for a historical problem that needs to be solved and then maps different workloads/neural networks to that initial architecture.

In a related application, entitled PROCESSOR ARCHITECTURE MODELING FOR DEEP LEARNING filed on Jul. 14, 2023, U.S. patent application Ser. No. 18/352,602, which also claims priority to U.S. Ser. No. 63/389,673, filed Jul. 15, 2022. and filed concurrently herewith, neural network targets (e.g., model accuracy, performance, power) are defined and, after a neural network model is generated using AutoML, a chip architecture is created that can satisfy those constraints along with the neural network model—in a fully automated flow.

In the presently disclosed and claimed technology, a methodology to create the processor architecture as a companion to the neural network model. More specifically, a methodology to model a plurality of chip architectures for simple compilation flows enables architectural exploration and provide a way to model the spatial architecture of a TSP processor such as the GrogChip™ processor. The compilation can be implemented for any arbitrary spatial TSP architecture using either ASIC or FPGA devices. That is to say, the TSP architecture can be uniquely defined for a selected ML or AI model without having to update the software compiler.

The compiler-driven architecture exploration enables performance advantages over systems that rely on a single CPU or GPU architecture.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF THE DRAWINGS

The following Detailed Description, Figures, and Claims signify the uses of, and progress enabled by one or more ECINs. All the Figures are used only to provide knowledge and understanding and do not limit the scope of any ECIN. Such Figures are not necessarily drawn to scale.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

FIG. 1 depicts an embodiment for a composer and a compiler for the purposes of the present technology.

FIG. 2 illustrates a prior art system for compiling programs to be executed on a tensor processor, according to an embodiment.

FIG. 3A illustrates the flow of instructions within a preferred prior art processor architecture, while FIG. 3B illustrates the flow of data within the preferred prior art processor architecture according to an embodiment.

FIG. 4 depicts a compiler block diagram for compiling a PyTorch, TensorFlow or other software model into binary for a target processor in accordance with an embodiment for the purposes of the present technology.

FIG. 5 depicts an embodiment of the process for composing an Abstraction Model of the processor core for the purposes of the present technology.

FIG. 6 depicts a Functional Unit (FUnit) abstraction in accordance with an embodiment for the purpose of the present technology.

FIG. 7 depicts a building block diagram of an interconnect system in accordance with an embodiment for the purpose of the present technology.

FIG. 8 depicts, in part, the foundational structure of the Operation Information Table in accordance with an embodiment for the purpose of the present technology.

FIG. 9 depicts a FUnit having In Ports and the Out Port that enable the FUnit to interconnect with SRF stream registers in accordance with an embodiment for the purpose of the present technology.

FIGS. 10A and 10B depict two levels of abstraction for a plurality of functional units coupled to a plurality of stream registers in accordance with an embodiment for the purpose of the present technology.

FIG. 11 depicts a FU Group in accordance with an embodiment for the purpose of the present technology.

FIG. 12 depicts various architectures that can comprise a General Chip Model (GCM) which is generated by a hardware composer and delivered to a compiler in accordance with an embodiment for the purpose of the present technology.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures, or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined for presentation and for illustration purposes and not be specified in detail. To not diminish the significance of these embodiments and/or examples, some well-known processes, machines, systems, manufactures, or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

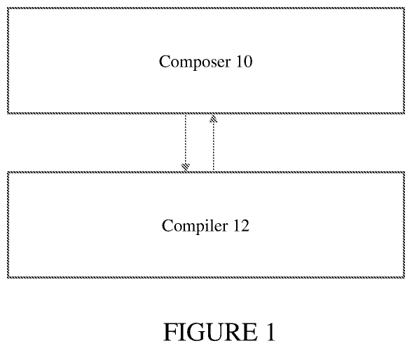

FIG. 1 depicts an ECIN that discloses a way to model a deterministic architecture within a composer 10 which interfaces with a deterministic compiler 12. The combination provides a generalized approach to modeling functional unit types that can be made available to the compiler. Composer 10 works in conjunction with compiler 12 to map deep learning or HPC workloads to an array of functional units. This unique functionality is accomplished by creating abstractions to model each functional unit in the chip architecture based on baseline semantics. Composer 10 spatially arranges the functional units to meet the design targets and provides the spatial arrangement to the compiler. Compiler 12 can compile to any architecture that contains those baseline functional units and generate detailed throughput, latency and power parameters for the selected arrangement. If composer 10 is satisfied with the results the architectural arrangement is used to manufacture a new chip based on the architecture. The composer and compiler are programs that execute on a computer system. Programs and computer systems are described below.

In one or more ECINs disclosed herein an optimized compilation of a machine learning model such as a TensorFlow model is obtained from AutoML. The model is fed into a compiler, which in one embodiment, generates a directed acyclic graph (DAG) of the model, rewrites the operators in the model into special purpose hardware instructions, schedules the hardware instructions down to each clock cycle, optimizes the instructions within desired runtime constraints, and assembles the scheduled instructions with constraint metadata in a binary that can be delivered to a special purpose processor that executes the instructions within the binary. The processor executes the instructions to process data inputs for the machine learning model and generates output corresponding to the output of the predictive model. Furthermore, the execution of the model in the processor results in performance that conforms to the stated constraints indicated in the constraint metadata. These constraints may include time to execute, power used, memory used, heat generated, etc. This allows a designer or other user to include the processor with compiled binary as a component in a larger device knowing that the processing of the machine model will always be within the stated constraints and not exceed them.

Compiler 12 may interface with an automated machine learning (AutoML) tool to automate the tasks of applying machine learning to real-world problems. AutoML may include every stage from beginning with a raw dataset to building a machine learning model ready for deployment or a subset of such stages as selected by a user.

AutoML is an artificial intelligence-based solution to the growing challenge of applying machine learning. Thornton C, Hutter F, Hoos H H, Leyton-Brown K (2013). Auto-WEKA: Combined Selection and Hyperparameter Optimization of Classification Algorithms. KDD '13 Proceedings of the 19th ACM SIGKDD international conference on knowledge discovery and data mining. pp. 84T-855.

The high degree of automation in AutoML aims to allow the use of machine learning models and techniques without requiring experts in machine learning. Automating the process of applying, machine learning techniques additionally offers the advantages of producing simpler models, faster creation of those models, and models that often outperform hand-designed models. See for example, https://www.automl.org/automl/.

In AutoML, hyperparameter optimization or tuning is the process of selecting a set of optimal hyperparameters for a learning algorithm. A hyperparameter is a parameter, the value of which is used to control the learning process, a hyperparameter refers to a configuration setting that is external to the model and is not learned from the data. Hyperparameters influence the behavior and performance of the deep learning model during training and inference. They are set by the user or researcher before the training process begins and remain fixed throughout the training process. Optimal hyperparameter values can significantly impact the models performance, convergence speed, and generalization ability. Hyperparameter tuning involves selecting the most appropriate values for these settings through methods such as grid search, random search, or more advanced techniques like Bayesian optimization or evolutionary algorithms.

In a typical machine learning application, practitioners have a set of input data points that is used for training. The set of input data, which might be in a raw form, may not be in a form all algorithms can be applied to. To make the data amenable for machine learning, an expert may have to apply appropriate data pre-processing, feature engineering, feature extraction, and feature selection methods. After these steps, practitioners must then perform algorithm selection and hyperparameter optimization to maximize the predictive performance of their model. If deep learning is involved, the machine learning expert must also choose the architecture of the neural network. Clearly, this may be an iterative process involving multiple attempts to identify a tuned model that meets performance requirements.

Each of these steps may be challenging, resulting in significant hurdles to using machine learning but AutoML simplifies these steps for users and makes the practice of developing machine learning models more efficient. AutoML can target various stages of the machine learning model development. For example, automated steps may include: (i) feature extraction; (ii) meta learning and detection and handling of skewed data and/or missing values; (iii) model selection-choosing Which machine learning algorithm to use, often including multiple competing software implementations; (iv) assembling a consensus of multiple models to give better results than a single model; (v) hyperparameter optimization of the learning algorithms and featurization; (vi) pipeline selection under time, memory, and complexity constraints; (vii) selection of evaluation metrics and validation procedures; (viii) problem checking; (ix) leakage detection; (x) misconfiguration detection; (xi) analysis of obtained results; and (xii) creating user interfaces and visualizations.

### Example 1

For a given model, AutoML provides the framework to define inputs one can use to configure the model and the model's input data and accuracy. That model is then compiled to determine the optimal chip architecture in terms of memory and compute resources for the specified model that meets a target performance (latency/throughput), target accuracy of the workload, target power limit for the specified model. In one embodiment, AutoML creates custom neural networks automatically based on input data and accuracy targets.

In an ECIN, a specific application is selected from the group consisting of deep learning algorithms including but not limited to computer vision, speech recognition, natural language processing, machine translation, bioinformatics, drug design, medical image analysis, climate science, material inspection d board game algorithm.

In another ECIN implements AutoML and a deterministic architecture (for the reference, please, see U.S. Ser. No. 17/203,214, filed Mar. 16, 2021) to achieve a performance (latency and throughput) and power targets and chip architecture (memory and compute capacity) that meets those targets for the generated neural network.

More specifically, whereas the conventional AutoML generally assumes a static chip architecture to run the generated neural network, the present technology does not have to make that assumption. Rather, a “composable” deterministic architecture enables the tool to selectively increase (or decrease): vector sizes, the number and layout of functional units such as memory, VXMs, MXMs, SXMs as well as the number of superlanes, stream registers, and off-chip connectors to obtain predictable performance, power, and area. This is much more difficult with other architectures like a GPU or CPU because of the inherent lack of knowledge of the timing when a specific instruction will execute due to the non-deterministic nature of those architectures.

With a composable architecture on the hardware side, the deterministic compiler is agnostic to changing vector sizes and the structure and arrangement of the functional units.

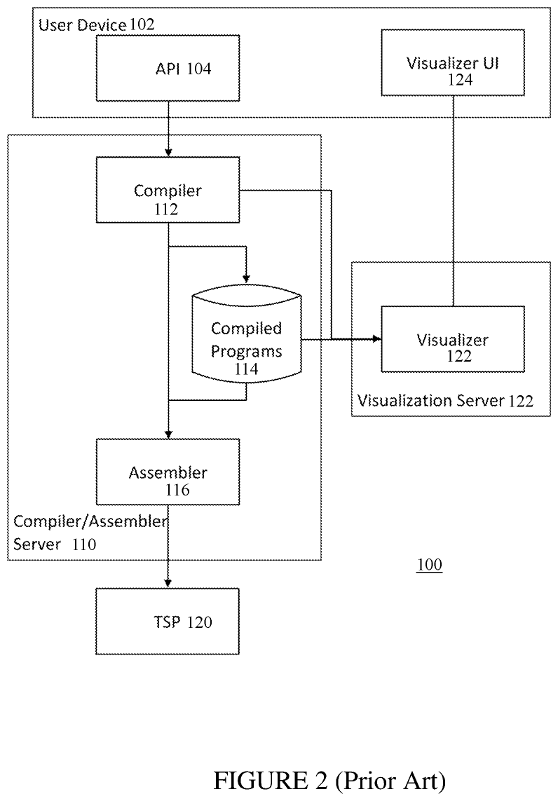

The AutoML developed model is then compiled by compiler 12. More specifically, FIG. 2 illustrates a system 100 for compiling programs to be executed on a tensor processor, and for generating power usage information for the compiled programs, according to an embodiment. The system 100 includes a user device 102, a server 110, and a processor 120. Each of these components, and their sub-components (if any) are described in greater detail below. Although a particular configuration of components is described herein, in other embodiments the system 100 have different components and these components perform the functions of the system 100 in a different order or using a different mechanism. For example, while FIG. 2 illustrates a single server 110, in other embodiments, compilation, scheduling, assembly, and power usage functions are performed on different devices. For example, in some embodiments, at least a portion of the functions performed by the server 110 are performed by the user device 102.

The user device 102 comprises any electronic computing device, such as a personal computer, laptop, or workstation, which uses an Application Program Interface (API) 104 to construct programs to be run on the processor 120. The server 110 receives a program specified by the user at the user device 102, and compiles the program with compiler 112 to generate a compiled program 114. In some embodiments, a compiled program 114 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 112 is a TensorFlow compiler and the processor 120 is a tensor processor. In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 120 is a tensor processor having a functional slice architecture, the compiler 112 generates an explicit plan for how the processor will execute the program, by translating the program into a set of operations that are executed by the processor 120, specifying when each instruction will be executed, which functional slices will perform the work, and which stream registers will hold the operands. This type of scheduling is known as “deterministic scheduling”. This explicit plan for execution includes information for explicit prediction of excessive power usage by the processor when executing the program.

The assembler 116 receives compiled programs 114, generated by the compiler 112, and performs final compilation and linking of the scheduled instructions to generate a compiled binary. In some embodiments, the assembler 116 maps the scheduled instructions indicated in the compiled program 114 to the hardware of the server 110, and then determines the exact component queue in which to place each instruction.

The processor 120, e.g., is a hardware device with a massive number of matrix multiplier units that accepts a compiled binary assembled by the assembler 116, and executes the instructions included in the compiled binary. The processor 120 typically includes one or more blocks of circuitry for matrix arithmetic, numerical conversion, vector computation, short-term memory, and data permutation/switching. Once such processor 120 is a tensor processor having a functional slice architecture. In some embodiments, the processor 120 comprises multiple tensor processors connected together to form a single core.

A tensor is a family of mathematical structures that includes vectors, matrices and higher dimensional arrays. Tensors are used in many fields of science and engineering, and huge tensors with millions to billions of elements are used in numerical calculations such as machine learning, one operation—multiplication—requiring huge amounts of processing power for large tensors, for which specialized processors have been developing in recent years.

One type of a tensor processor is a deterministic (the time and location of all instruction executions known before execution), for example, the tensor streaming processors (TSPs) sold by Groq Incorporated. These types of deterministic processors comprise a two-dimensional mesh of processor cores, where data flows across lanes and instructions flow across slices.

In this organization, each computational element implements a specific function and is stacked vertically into a specific “functional slice” in one dimension (e.g., the Y-dimension) of the two-dimensional on-chip mesh. Each functional slice is independently controlled by a sequence of instructions specific to its on-chip role. For instance, the MEM functional slices support Read and Write but not, necessarily Add or Mul, which are typically performed in arithmetic functional slices (e.g., the vector execution module (VXM) and matrix execution module (MXM) functional slices) for some typical machine learning (ML) algorithms, such as the linear regression algorithm. In the X dimension, each functional row comprises a full set of different types of functional cores, e.g., MEM, VXM, MXM, SXM etc. We call each functional row a superlane. In some embodiments, a visualization server 122 may take the compiled program and use a visualizer tool 122 to create a graphical representation of the data flow across the various columns of functional units. The representation may be displayed on a visualizer UI device 124. Visualizer UI 124 may be helpful to identify resource utilization.

Example Processor

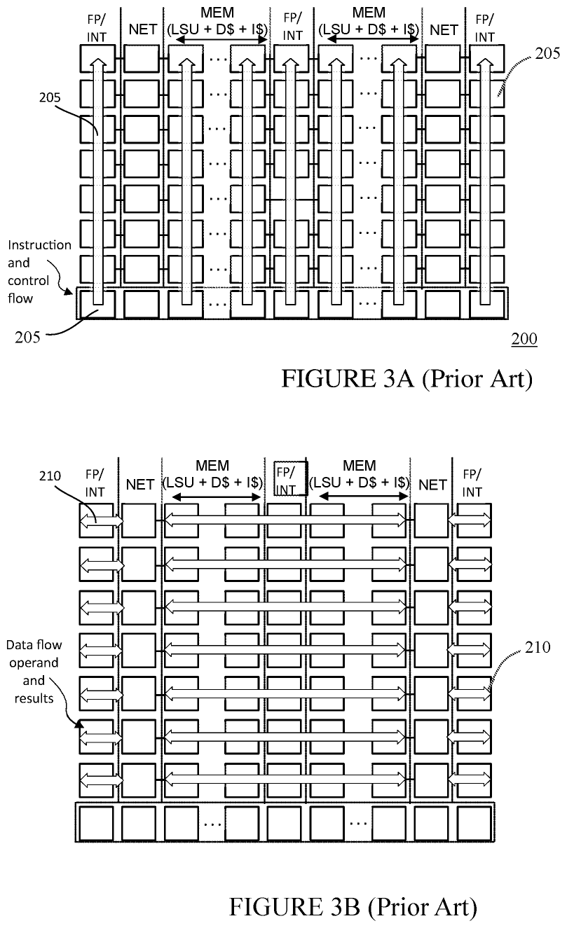

FIGS. 3A and 3B illustrate instruction and data flow in a processor having a functional slice architecture, in accordance with some embodiments. One enablement of processor 200 is as an application specific integrated circuit (ASIC), and corresponds to processor 120 illustrated in FIG. 2.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In some embodiments, the NIM is implemented as part of the MXM. In other embodiments, each tile may include an aggregation of functional units such as a tile having both the MEM and vector execution units by way of example. As illustrated in FIGS. 3A and 3B, each slice corresponds to a column of N functional units extending in a direction different (e.g., orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 210 that connects a row of functional units of adjacent slices is referred to as a “super-lane”, and comprises multiple data lanes, or “streams”, each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 3A illustrates the flow of instructions within the processor architecture, while FIG. 3B illustrates the flow of data within the processor architecture. As illustrated in FIGS. 3A and 3B, the instructions and control signals flow in a first direction across the functional units of processor 200 (e.g., along the length of the functional slices 205), while the data flows 210 flow in a second direction across the functional units of processor 200 (e.g., across the functional slices) that is non-parallel to the first direction, via the communication lanes (e.g., super-lanes) connecting the slices.

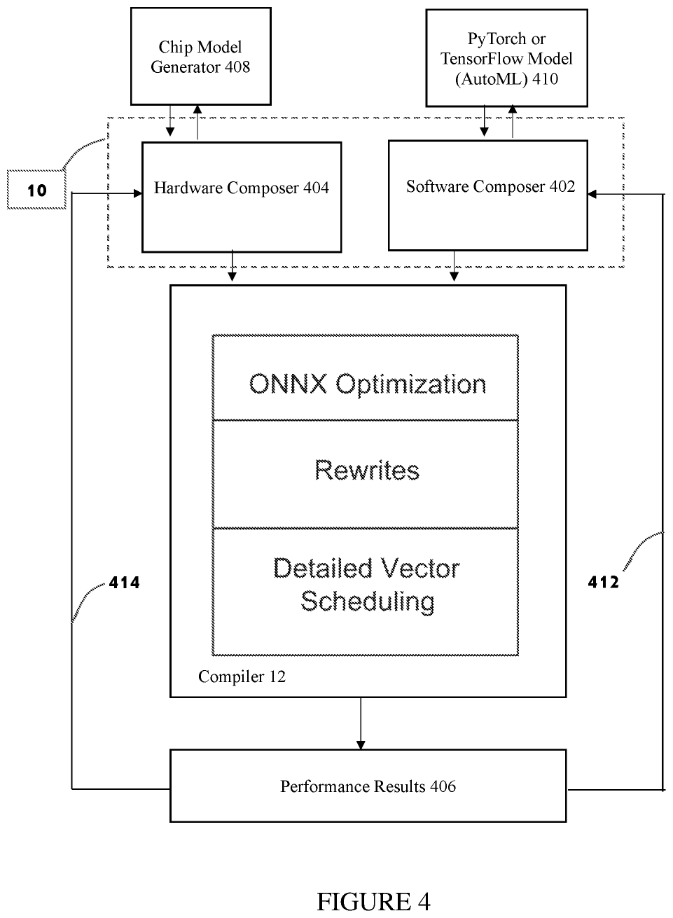

In some embodiments, the functional units in the same slice execute instructions in a ‘staggered’ fashion where instructions are issued tile-by-tile within the slice over a period of N cycles. For example, the ICU for a given slice may, during a first clock cycle, issues an instruction to a first tile of the slice (e.g., the bottom tile of the slice as illustrated in FIG. 4B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results typically flow in the opposite direction where they are then written back to memory or consumed by another functional unit. For example, a first data flow from a first memory slice flows in a first direction (e.g., towards the right), where it is intercepted by a VXM slice that performs a vector operation on the received data. The data flow then continues to an MXM slice which performs a matrix operation on the received data. The processed data then flows in a second direction opposite from the first direction (e.g., towards the left), where it is again intercepted by VXM slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by VXM slice before traveling to the second MXM slice. The results of the matrix operation performed by the second MXM slice then flow in the first direction back towards the second memory slice.

In some embodiments, stream registers (not shown) are located along a super-lane of the processor, in accordance with some embodiments. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler, and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the TSP's basic data type is an INT8, each register may be 8-bits wide). In some embodiments, in order to support larger operands (e.g., FP16 or FP32), multiple registers are collectively treated as one operand, where the operand is transmitted over multiple streams of the super-lane.

All of these functional features—superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

In accordance with an ECIN, predictable performance projections are generated during an iterative process of composing a chip architecture that will execute a selected model to meet selected design and performance criteria. The selected criteria is preferably based on a set of input data, power, performance (latency & throughput) constraints and accuracy targets of the application, (e.g., 80% accurate prediction of results) for a starting neural network architecture and an initial chip architecture. The process for composer 10 is depicted in FIG. 1.

Once the selected model is trained, the speed at which the model runs on a selected architecture is determined by compiler 12. If execution meets all constraints (power, performance, etc.) the model as compiled for a specific hardware architecture is satisfactory, the results are reported out.

If, on the other hand, the model is not satisfactory, composer 10 automatically updates the chip architecture, the model architecture or the compiled model parameters to identify an optimal combination.

More specifically, model updates can also include addition of more layers, or removing unnecessary layers, by using the AutoML techniques, and iterate (i.e., train the new model, and run the new model on the existing version of the chip architecture or on different architectures) until composer 10 achieves the required performance. Compiled model parameters can be adjusted, by way of example, as described in the commonly assigned U.S. patent application entitled Power Management during High Current Events, Ser. No. 63/440,910 filed on Jan. 24, 2023, the disclosure of which is incorporated herein by reference.

To determine how to adjust the initial chip architecture prior to first silicon being available for emulation, composer 10 may selectively scale selective hardware features, such as vector length, the number of streams, the number of functional slices, the number of time zones, and/or the number of functional units in a slice. Composer 10 may also selectively spatially change the positioning of each slice in each time zone relative to an initial slice position template.

To understand if the user includes “infeasible” constraints, an “infeasible” iteration criterion can be introduced to generate a user report if the constraints cannot be met for the given power/performance goals. For example, if performance is too high and power is too low, it might not be possible to implement in a real design.

Heuristics are developed to adjust the hardware features and positioning of the hardware features to identify resource bottlenecks when executing the model. Composer 10 may then scale up those resources or spatially re-arrange the resource location in the next iteration to improve performance or scale down under utilized resources to reduce power.

In one embodiment, the bottlenecks can be identified by composer 10 and those bottlenecks can be used to help the tool to adjust the chip architecture as disclosed in the related application entitled PROCESSOR ARCHITECTURE MODELING FOR DEEP LEARNING to be filed on Jul. 14, 2023, which also claims priority to U.S. Ser. No. 63/389,673 filed Jul. 15, 2022.

FIG. 4 illustrates how a compiler 12 first translates a PyTorch, TensorFlow or other model into ONNX code that can be optimized and rewritten as an intermediate representation that is compatible with the TSP. Then, compiler 12 creates a detailed schedule of the input model as it will be executed by the TSP or other processor. ONNX (Open Neural Network Exchange) is an open-source format and development system designed to facilitate interoperability between deep learning frameworks and tools. It provides a standardized way to represent and exchange deep learning models, allowing models trained in one framework to be used in other frameworks without the need for extensive code modifications or reimplementations. More specifically, ONNX enables the conversion of models trained in popular deep learning frameworks, such as TensorFlow, PyTorch or Keras, into a standardized intermediate representation. This representation allows the models generated by AutoML to be consumed by the compiler to create a binary for execution by the target processor, which in a preferred embodiment is a TSP. Once the schedule is known, the performance results are tallied to see if the initial design constraints are satisfied. If the processor is a deterministic processor such as a TSP, the performance results will be the exact simulation results which is obviously a desirable outcome.

If the performance results are deficient, compiler 12 can redirect the compilation process to select the software composer 402 which in one embodiment a module of composer 10. Software composer 402 may invoke AutoML to modify the PyTorch or TensorFlow model 410 as indicated by process sequence 412. Thus, in one embodiment of the compilation process, compiler 12 can iteratively select different versions of the model or, alternatively, select a different model with repeatable exact results being returned each iteration for comparison to the design constraints. If after a selected number of iterations, compiler 12 determines that it is infeasible to meet the design constraints, the compilation process may invoke the hardware composer 404 as indicated by process sequence 414.

Hardware composer 404 has access to a plurality of processor architectures which are provided by chip model generator 408. Hardware composer 404 uses the chip model generator templates to compose a processor architecture better suited to address resource constraints by adding additional resources to the processor architecture or by reducing selected resources that are under utilized for one or more of the PyTorch or TensorFlow models.

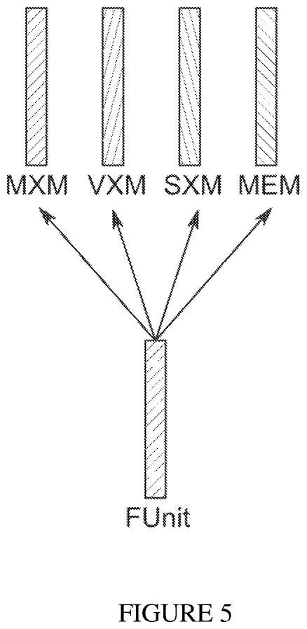

FIG. 5 depicts an embodiment of the process for composing an Abstraction Model of the processor core for the purposes of the present technology. Here a functional unit provides the foundational Abstraction Model for each of the functional units that the processor uses to execute a software model prior to the availability of first silicon. The composable abstraction Model combined with the deterministic compiler means the compiler can generate detailed accurate performance results for a variety of chip architectures without the need for simulators or emulators.

In one ECIN, C++ provides powerful language features to build the Abstraction Model of a deterministic spatial architecture, specifically the hierarchy, RTTI, FU types and templates. Hierarchy refers to the organization and arrangement of modules or components in a chip design. It involves structuring the design into different levels of abstraction, such as modules, sub-modules, and individual components. Hierarchy helps manage the complexity of chip designs by breaking them down into smaller, more manageable units, allowing for easier understanding, reusability, and efficient design processes.

RTTI (Run-Time Type Information) is a feature in some programming languages and development frameworks that provides information about the type of an object at runtime. In chip design, RTTI can be used to enable dynamic behavior and configuration based on the types of components or signals during runtime. In C++, RTTI is supported through two main mechanisms: dynamic_cast and typeid. The dynamic_cast operator is used to perform dynamic type casting at runtime. It converts a pointer or reference to a base class into a pointer or reference to a derived class. If the conversion is not possible, dynamic_cast returns a null pointer or throws a std::bad_cast exception, depending on the context. The typeid operator obtains the type information of an object at runtime. It returns a std::type_info object that represents the actual type of the object.

FU (Functional Unit) Types are the individual building blocks within a chip that perform specific functions or operations. FU types refer to different categories or types of functional units based on their intended purpose or functionality. For example, an FU type could represent an arithmetic unit, a memory unit, a control unit, or any other specialized functional block within the chip. Other types of FUs may be derived depending on the specific application.

Templates, in the context of chip design, typically refer to reusable design patterns or building blocks to accelerate the design process. These templates provide predefined structures, modules, or components that can be customized and instantiated for specific chip designs. In various ECINs, templates include chip to chip connectors, input ports and stream registers modules. Templates offer a way to capture design knowledge, promote reusability, and streamline the development of chip designs by providing a starting point or framework.

Each of these building blocks enable hardware composer 404 to organize, customize, and optimize the architecture of a chip for a specific application or functionality based on performance results 406.

In one ECIN, the TSP architecture provides a natural fit for an abstraction model containing all information needed for compilation. Chip model generator 408 provides a plurality of specialized FUs with a common interface, specifically a C++ to templated polymorphism where all instruction timing is resolvable at compile time via a simple lookup table (not shown).

Further, once the architectural layout is identified, all data movement is resolvable at compile time. With the TSP architecture, the one dimensional interconnect abstracted as “timezone” indices enables the efficient cycle-accurate resource allocation tracking via specialized data structures such as, by way of example, bit vectors for fast range-allocation & lookup across time and space. Thus, the combination of hardware composer 404 and compiler 12 provide a powerful hardware-software co-design tool because there are no reactive components, and all functional units are fixed in terms of latency and size, the compiler can model performance 100% accurately and generate a performance characterization of the chip for any given architecture long before tapeout or manufacturing.

In one ECIN, composer 404 passes a General Chip Model (GCM) to compiler 12 wherein the GCM defines the fundamental structure of the chip (e.g., processor) architecture. As long as a chip architecture adheres to this fundamental structure, the compiler is fully aware of both data and instruction flow as well as resource utilization. This fundamental structure sets the bounds of what the compiler supports because it represents all of the architecture information needed by the compiler. Specifically, the fundamental structure provides connectivity, timing, relative positions, and number of functional units to the compiler in a time-efficient manner.

Details regarding the software composer 402 are described more fully in the above referenced commonly assigned related application entitled PROCESSOR ARCHITECTURE MODELING FOR DEEP LEARNING to be filed on Jul. 14, 2023, which also claims priority to U.S. Ser. No. 63/389,673 filed Jul. 15, 2022, which is incorporated herein in its entirety.

FIG. 5 illustrates how, in one ECIN, the C++ abstractions are leveraged for the purposes of the present technology. Specifically, a FU template (FUnit) may be composed as one of the following: a MXM FU for matrix-vector and matrix-matrix multiply operations in various integer and floating point numerical representations such as INT8 to FP32, a MEM FU for memory structure for storing bytes of data, a VXM for arithmetic and logical vector operations in various boolean and integer and floating point numerical representations, a SXM for switching and permutation operations. Other FUs may be designed using the FU template for other sets of specialized operations. In the preferred embodiment, a deterministic architecture allows exact performance to be known at compile time—no hardware needs to be profiled (e.g., there is no need to receive first silicon from the foundry) and no need to develop a cycle accurate simulator to perform simulations of the processor's revised architecture.

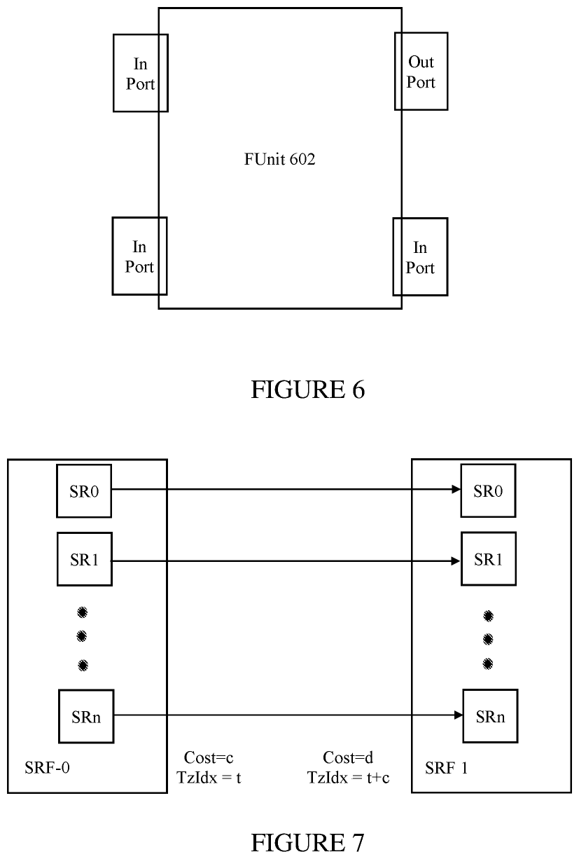

FIG. 6 depicts, in part, the foundational structure of the chip's abstraction for the purposes of the present technology. More specifically, in one embodiment, the GCM comprises a FU building block 602 for each compute and memory unit (memory is treated as a functional unit). Each FU building block 602 has some number of input ports and output ports. For example, FU building block 602 has three input ports and one output port. In other embodiments, there may be two output ports and two or more input ports depending on the functionality implemented by the functional unit. FU602 defines where instructions are issued on chip and also specifies connectivity and concurrency.

FIG. 7 depicts, in part, the foundational structure of the Stream Register Paths (SRP) which form the backbone of the chip-wide communication network. An SRP consists of a chain of Stream Register Files (SRF). Each SRF includes a plurality of stream registers (0, 1, 2, . . . n) that transmit data in a direction as indicated by the arrows in the figure. Each stream register in each SRF is connected to the stream register of the same ID in the next SRF in the SRP. For example, in FIG. 7, stream register SR0 in SRF0 is connected to stream register SR0 in SRF1. Each SRF has a cost associated with it, which represents the time it takes to send data across a stream register in this SRF. The TZIDX of an SRF indicates the amount of time it takes to send data to a stream register in this SRF if the data began at the beginning of the SRF chain. For example, SRF0 has a Cost=c and a TZIDX of time t and SRF1 has a Cost=d and a travel time TZIDX of time t+c.

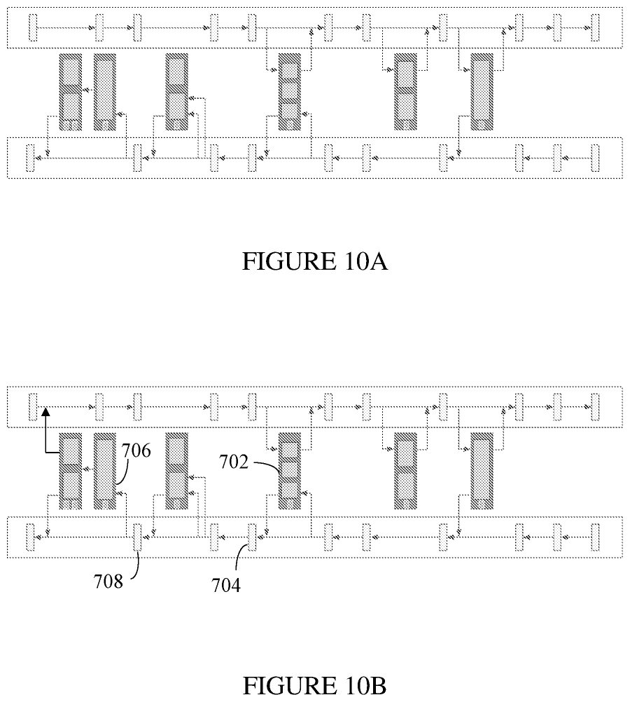

FIG. 9 depicts, in part, the connectivity of a Functional Unit (FU) to two Stream Register Paths (SRP). The timing and connectivity relationship between FUs in the GCM is defined by their connectivity to the set of SRPs included in the GCM. A FU has multiple input and output ports, with each port connecting to one or more stream registers contained within one or more Stream Register Files (SRF). As explained above, each SRF is part of an SRP. Two FUs in the GCM can pass data directly between one another if they connect to a stream register of the same ID within an SRP. For example, as depicted in FIG. 10, a FU 702 of type VXM connected to stream register SR3 in SRF7 704 within SRP1 can send data to FU 706 of type MXM connected to stream register SR3 in SRF9 708 within SRP1. The time it takes to send data between the VXM and MXM in this example is defined by the sum of the Costs of all SRFs between SRF7 and SRF9.

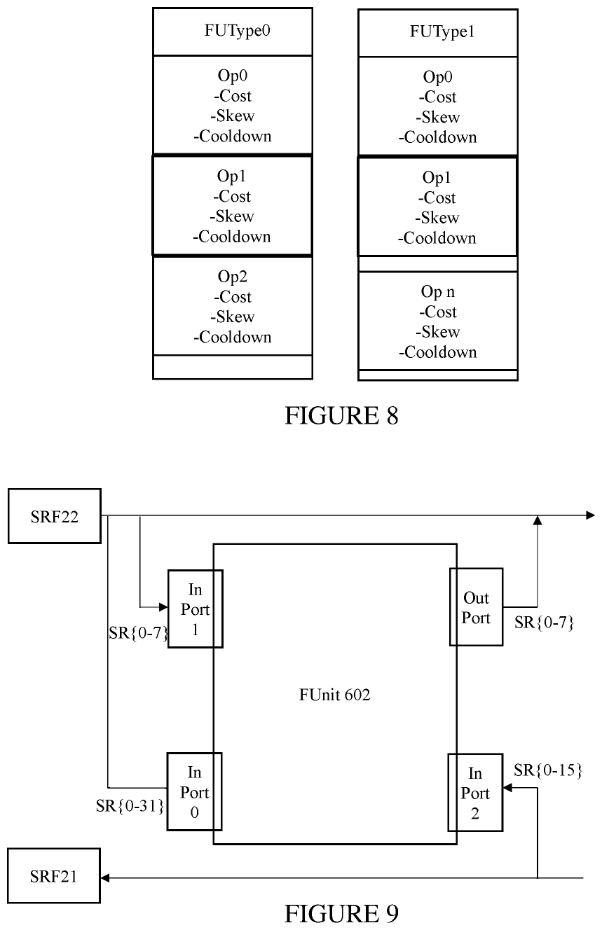

FIG. 8 depicts, in part, the foundational structure of the Operation Information (or Op Info) Tables. Each FUnit 602 has a corresponding OP Info Table that defines the Instruction Set for the FUnit 602. The Op Info Tables also define instruction specific timing information for each instruction in the Instruction Set. The timing information for a given instruction includes 1) Cost, defined as the time between instruction being issued and instruction result being produced at FUnit output; 2) Skew, defined as the time between instruction operands arriving at FUnit input and instruction being issued; and 3) Cooldown, defined as the minimum amount of time permitted between two instructions being issued. For example, a multiplier may have a cost of 8 clock cycles before an output would be available on the Out Port of the FUnit 602.

The GCM may further comprise a plurality of interface technologies (not shown) such as PCIe circuit blocks to provide connectivity to a host processor. These interface technologies are also represented using the Functional Unit template: they define their own instruction sets with their own timing characteristics, and they connect to specific stream registers within one or more SRPs.

The GCM may further comprise a plurality of chip-to-chip or die-to-die connectors (not shown) that allow multiple chips to exchange data at a much higher rate than is possible across the PCIe interface. Typically, such C2C or D2D connectors are positioned to couple superlanes on one chip to another chip. C2C and D2D connectors are known in the art and are not further discussed herein. Hardware composer 404 is able to populate the periphery of a chip with such connectors to enable efficient data transfer between chips. C2C and D2D connectors are also represented using the Functional Unit template: they define their own instruction sets with their own timing characteristics, and they connect to specific stream registers within one or more SRPs.

Refer now to FIG. 9 where the In Ports and the Out Port of a FUnit are depicted interconnected with SRF stream registers. In this embodiment, the FUnit 602 has two In Ports, specifically In Port 0 and In Port 1, connected to stream register SRF22 to receive a first and a second operand. In Port 0 has access to stream registers 0 to 31 within SRF22, while In Port 1 has access to stream registers 0 to 7 within SRF 22. In Port 2 is connected to stream register SRF21_ to receive a third operand. In this embodiment, Out Port is connected to stream register SRF21 where the results from the FUnit 602 will be produced. Further, each port defines which subset of stream registers (SR) within the SRF that the port has access to. As depicted, the In/Out Ports define stream register connectivity, which is then analyzed by the GCM to provide the compiler 12 the necessary architecture information related to FUnit connectivity and relative timing. For example, consider a FUnit A the produces results at an Out Port connected to SR0 within a SRF that has a TZIDX=6 clock cycles, and a FUnit B that accepts its operand at an In Port connected to SR0 within a SRF that has a TZIDX=10 clock cycles. The relative timing for data to be produced by FUnit A and accepted at FUnit B is therefore 10−6=4 clock cycles. This example illustrates the efficient representation of the architectural information provided by the GCM and necessary for the compiler 12 to perform cycle-accurate scheduling.

For given latency, throughput and power targets, the GCM allows hardware composer 404 and compiler 12 to discover any TSP architecture that includes the general template and any combination of blocks MXM, VXM, SXM, MEM, IO and other FUnit types that would be the best fit for the input Pytorch or Tensorflow model.

The GCM provides two sets of architecture description necessary for the compiler 12 to perform cycle-accurate scheduling: the first set of architecture description consists of the correct timing for the set of instructions within a given FUnit (e.g. MXM, VXM, SXM, MEM), which are defined by the costs, skews, and cooldowns within the FUnit's OpInfoTable. The second set of architecture description consists of the relative timing and connectivity between FUnits across a given architecture, which are defined by the SRPs and SR-to-FUnit-Port connections. The combination of these two sets of architecture description for a plurality of functional units coupled to a plurality of stream registers are depicted in FIGS. 10A and 10B. For example, with respect to FIG. 10B, a FU of type VXM 702 connected to stream register SR3 704 in SRF0 within SRP1 can send data to FU of type MXM 706 connected to stream register SR3 708 in SRF5 within SRP1. The time it takes to send data between the VXM and MXM in this example is defined by the sum of the Costs of all SRFs between SRF0 and SRF5.

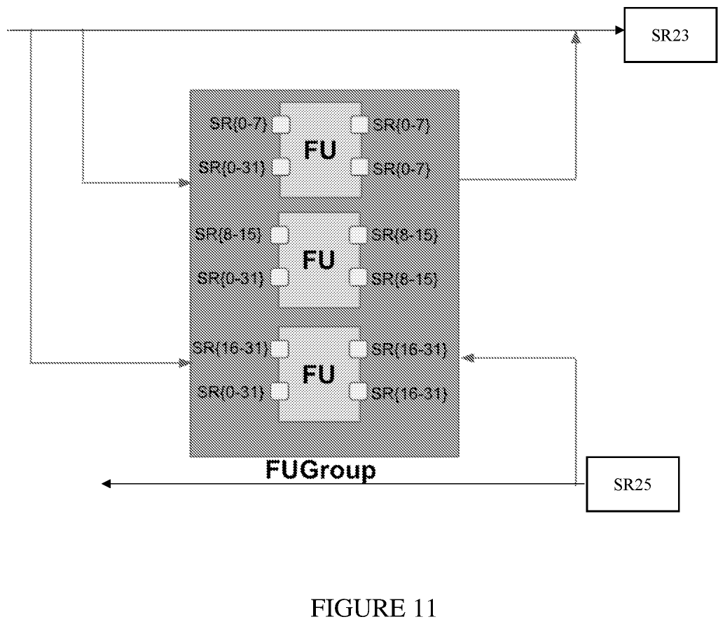

FIG. 11 depicts a FU Group. Specifically, each FUs in an FUGroup must: 1) be of the same type (e.g., MXM); 2) connect to the same SRFs; and 3) connect to the same FU groups. Each FUnits in a FUGroup therefore have the same timing characteristics. The FUGroup structure provides an efficient mechanism for the compiler 12 to look up timing information for a group of FUnits. Rather than lookup timing information for each FUnit in a FUGroup separately, the compiler 12 can now look up their timing information all at once.

The GCM provides a common interface for automatically populating and accessing the following architecture information: 1) the instruction set of each FUnit; 2) the cost, skew and cooldown of each instruction; 3) the latency between FUnits; 4) the FUnits' stream register connectivity; 5) relative position of different FUnits; and 6) groups of FUs that share the same timing characteristics.

Using the GCM developed by hardware composer 404, compiler 12 can target any architecture that fits within this model framework. Any of the following variations comprise a minimum set supported by the compiler without needing any code changes: 1) the number of FUnits of a certain type; 2) the SR candidates at a FUnit's port; 3) location of a FUnitGroup along a SRP; 4) the number of SRs within an SRF; 5) the number of SRPs; 6) the set of instructions supported by a given FUnit type; 7) the cost, skew and cooldown of a given instruction supported by a given FUnit type; and 8) the vector length of vector instructions supported by a given FUnit type. The GCM is generated by the hardware composer 404.

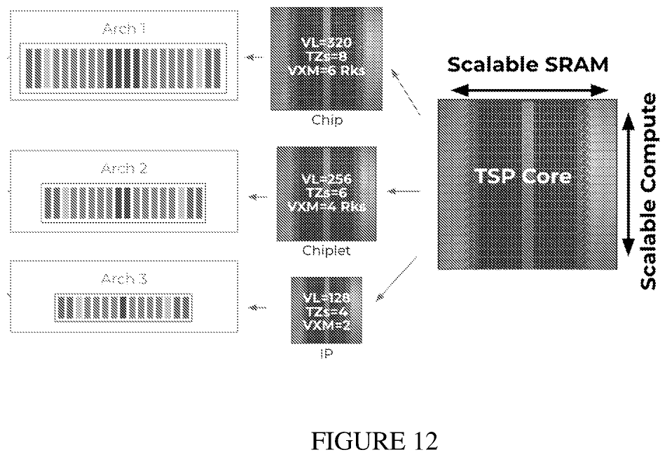

Hardware composer 404 can change the exact architecture of the TSP to make it more suitable to any individual input model by taking advantage of the full compiler software control over the TSP architecture. As depicted in FIG. 12, where different architecture parameters can be provided by Hardware Composer 404 depending on the requirements of the AI or ML model.

In one ECIN, FUnits can be arranged across multiple chiplets, see Arch 2, for example. In this example, the GCM can define one chiplet that may comprise mostly SRAM and VXM functional units. A second chiplet may be defined that comprises mostly MXM and SXM functional units. Compiler 12 would be able to compile a program that utilizes the functional units on the two chiplets and integrate those chips into a mosaic of chips that function as a single core.

Similarly, if a large model required a certain number of MXMs due to the first layer of a model having a massive matrix-matrix operations but subsequent layers have are dominated by vector-vector operations, it is now possible to construct a plurality of chip or chiplets so that each layer of the model may be processed by a chip specifically composed to have the functional units required to efficiently process that layer of the model. The fact that each chip comprising the plurality of chips differs from other chips, is of no significance to the compiler 12 as long as each chip adheres to the fundamental structure of the TSP architecture.

Compiler 12 can drive changes for the subsequent iterations of TSP architecture until the best fit to the input model to be computed is achieved by using the parameters of latency, throughput and power as criteria, for example, for the subsequent changes.

FPGA CAD tools have long been an example of hardware-software co-design via software abstractions of the chip. FPGA CAD compiles HDL down to a bitstream configuring the chip (LUTs DSPs, BRAM, routing). Metrics of the bitstream are statically determined (resource utilization, fmax). Compilation requires a detailed, low-level chip model. Verilog-to-Routing (VTR) is an open-source FPGA CAD tool used for FPGA architecture exploration. VTR can compile for any FPGA architecture that fits within its chip model framework. The current Groq compiler technology uses its own chip model with a different set of statically determined metrics (latency, throughput, power) to enable compiler-driven exploration of the TSP architecture. This technology thus enables the discovery of an optimum TSP architecture tailored to a specific optimized AI or ML model.

The present technology provides a commercial solution that is a process for efficiently implementing a program on a processor. The methodology described herein automatically models chip architectures to enable architecture exploration. This methodology models a spatial architecture, such as the GrogChip processor (a deterministic tensor streaming processor), commercially available from Groq, Inc. of Mountain View, California, in a generalized way, such that compilation can be implemented once for any arbitrary TSP spatial architecture. Advantageously, changing the Groq TSP architecture does not require a rewrite or update to the compiler.

### Detailed Description—Technology Support from Data/Instructions to Processors/Programs

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1579 [CAFC, 1994]). Data and information are physical objects, for example binary data (a ‘bit’, usually signified with ‘0’ and ‘1’) enabled with two levels of voltage in a digital circuit or electronic component. For example, data can be enabled as an electrical, magnetic, optical, or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning, and then distributing.”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’).). As used herein, a ‘grammar’ is a set of rules for determining the structure of information. Many forms of knowledge, learning, skills, and styles are authored, structured, and enabled—objectively— as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit—such components include resistors, memristors, capacitors, magnetic inductors, crystals, Josephson junctions, transducers, sensors, antennas, waveguides, etc. Active electronic components require a source of energy and can inject energy into a circuit—such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures—such components include switches, relays, protection devices (e.g., fuses, circuit breakers), heat sinks, fans, cables, wires, terminals, connectors, and printed circuit boards.

As used herein, the term ‘netlist’ is a specification of components comprising an electric circuit, and electrical connections between the components. The programming language for the SPICE circuit simulation program is often used to specify a netlist. In the context of circuit design, the term ‘instance’ signifies each time a component is specified in a netlist.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘I/O’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ ‘CPU’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’, ‘model’, ‘AI or ML model’ signifies a structured grammar for specifying sets of operations and data for use by modules, processors, and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, JavaScript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor, or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program and is typically not very accessible to or modifiable by the user of a computer. Computer programs and firmware are often specified using source code written in a programming language, such as C. Modules, circuits, processors, programs, and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### Detailed Description—Technology Support General Computer Explanation

The abstract diagrams of a computer system suitable for enabling embodiments of the claimed inventions are not shown.

The structure of a computer system typically includes at least one computer which communicates with peripheral devices via a bus subsystem. Typically, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem, comprising a memory subsystem and a file storage subsystem, user interface input devices, user interface output devices, and/or a network interface subsystem. The input and output devices enable direct and remote user interaction with the computer system. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Linux and/or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of a computer system is intended only as an example. Many other structures of a computer system have more or less components than the computer system disclosed above.

Network interface subsystem provides an interface to outside networks, including an interface to a communication network, and is coupled via the communication network to corresponding interface devices in other computer systems or machines. Communication networks can comprise many interconnected computer systems, machines, and physical communication connections (signified by ‘links’). These communication links can be wireline links, optical links, wireless links (e.g., using the Wi-Fi or Bluetooth protocols), or any other physical devices for communication of information. Communication network can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all types of devices and processes to transfer data and information into a computer or processor based system or onto a communication network. User interface input devices typically enable a user to select objects, icons, text, and the like that appear on some types of user interface output devices, for example, a display subsystem.

User interface output devices can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all types of devices and processes to transfer data and information out of computer system 10 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits, which use any of the above input or output devices.

Memory subsystem typically includes a number of memories including a main random-access memory (‘RAM’) (or other volatile storage device) for storage of instructions and data during program execution and a read only memory (‘ROM’) in which fixed instructions are stored. File storage subsystem provides persistent storage for program and data files, and can include a hard disk drive, a floppy disk drive along with associated removable media, a CD-ROM drive, an optical drive, a flash memory such as a USB drive, or removable media cartridges. If a computer system includes an input device that performs optical character recognition, then text and symbols printed on a physical object (such as paper) can be used as a device for storage of program and data files. The databases and modules used by some embodiments can be stored by file storage subsystem.

Bus subsystem provides a device for transmitting data and information between the various components and subsystems of a computer system. Although the bus subsystem is depicted as a single bus, alternative embodiments of the bus subsystem can use multiple buses. For example, a main memory using RAM can communicate directly with file storage systems using Direct Memory Access (‘DMA’) systems.

The memory can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### Detailed Description—Semantic Support

The signifier ‘commercial solution’ signifies, solely for the following paragraph, a technology domain-specific (and thus non-preemptive—see Bilski): electronic structure, process for a specified machine, manufacturable circuit (and its Church-Turing equivalents), or a composition of matter that applies science and/or technology for use in commerce to solve an unmet need of technology.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function, or characteristic, it is within the knowledge and understanding of a skilled person to use such feature, structure, function, or characteristic in connection with another ECIN whether explicitly described, for example, as a substitute for another feature, structure, function or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described but is to be accorded the widest scope consistent with the disclosed principles and features. Without limitation, any and all equivalents described, signified or Incorporated by Reference (or explicitly incorporated) in this patent application are specifically incorporated into the Detailed Description. In addition, all variations described, signified, or incorporated with respect to any one ECIN also can be included with any other ECIN. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the claims.

What is claimed is:

1. A system for efficiently executing an artificial intelligence or machine learning model (model) comprising a composer for generating a General Chip Model (GCM) and a compiler for compiling the artificial intelligence or machine learning model for execution by a composable processor architecture and generating a compiled program for execution on a processor having the composable processor architecture.

2. The system of claim 1, wherein the composer comprises a hardware composer.

3. The system of claim 2, wherein the hardware composer generates an Operation Information Table for use by the compiler when compiling a model.

4. The system of claim 3, wherein the Operation Information Table represents operational characteristics of a functional unit.

5. The system of claim 4, wherein the Operation Information Table comprises cost, skew and cooldown information for use by the compiler when compiling a model for execution on a processor architecture prior to first silicon.

6. The system of claim 2, wherein the hardware composer generates a processor architecture by selectively adding additional resources to the processor architecture or reducing selected resources that are under utilized when a selected model is being compiled by the compiler.

7. The system of claim 6, wherein the hardware composer generates a processor architecture for each layer of the model.

8. The system of claim 6, wherein the processor architecture for each layer of the model is manufactured as a semiconductor processor for executing the model.

9. The system of claim 6, wherein the hardware composer generates a processor architecture selected from a library.

10. A method for efficiently executing an artificial intelligence or machine learning model (model) comprising:
generating a General Chip Model (GCM);
compiling the artificial intelligence or machine learning model for execution by a composable processor architecture wherein the composable processor architecture is defined by the GCM; and
generating a compiled program for execution on a processor comprising the composable processor architecture.

11. The method of claim 10, wherein the GCM is generated by a hardware composer coupled to a composer.

12. The method of claim 11, wherein the hardware composer further generates an Operation Information Table for use by a compiler when compiling a model.

13. The method of claim 12, wherein the Operation Information Table represents operational characteristics of a functional unit.

14. The method of claim 13, wherein the Operation Information Table comprises cost, skew and cooldown information for use by the compiler when compiling a model for execution on a processor architecture prior to first silicon.

15. The method of claim 11, wherein the hardware composer generates a processor architecture by selectively adding additional resources to a first processor architecture defined by a GCM or selectively reducing selected resources that are under utilized when a selected model is compiled by a compiler.

16. The method of claim 11, wherein the hardware composer generates a processor architecture for each layer of the model to be compiled.

17. The method of claim 11, wherein the processor architecture is manufactured as a semiconductor processor for executing the model.

18. The method of claim 11, wherein the hardware composer generates a processor architecture selected from a library.

19. The method of claim 11, wherein the hardware composer generates a plurality of processor architectures where each processor architecture is adapted to executing a layer of a model.

20. A machine-readable storage medium, comprising executable instructions that, when executed by a processor, facilitate performance of operations, the operations comprising:
generating a General Chip Model (GCM);
compiling an artificial intelligence or machine learning model for execution by a composable processor architecture wherein the composable processor architecture is defined by the GCM; and
generating a compiled program for execution on a processor comprising the composable processor architecture.
